(19) United States
(12) Patent Application Publication
(10) Pub. No.: US 2006/0239446 A1
(43) Pub. Date: Oct. 26, 2006

(54) Headwear apparatus

(76) Inventors: David Charles Gunter, Hayes (GB); Timothy Robert Burnham, High Wycombe (GB); Raymond Derek Cozens, Stevenage (GB)

Correspondence Address: LOWE HAUPTMAN BERNER, LLP, 1700 DIAGONAL ROAD, SUITE 300, ALEXANDRIA, VA, 22314, US

(21) Appl. No.: 11/357,411

(22) Filed: Feb. 21, 2006

(30) Foreign Application Priority Data
Apr. 20, 2005 (GB) 0507984.3

(51) Int. Cl. H04M 1/00

(52) U.S. Cl. 379/430

(57) ABSTRACT

Headwear (1) including a platform member (9) for use with a headset apparatus (2), the platform member defining an orifice (10A, 10B) therein and shaped to be placed adjacent and to surround an ear of the wearer to expose the ear though the orifice, wherein the platform member has a platform part (9A) moveable relative to another platform part (9B) to releasably hold between the platform parts at least a part of the headset apparatus thereby to detachably attach the headset apparatus to the platform member.

The present invention relates to headwear apparatus. For example, though not exclusively, the invention is concerned with audio communications headwear.

Conventional lightweight audio communication headwear devices typically include a communications headset with an earphone and are often required to be worn with the earphone in contact with or very near to the entrance of the ear of the wearer of the headset. This positioning is, of course, preferable in order to permit the wearer to easily hear audio communications emanating from the earphone.

Depending upon the circumstances in which the wearer of the headwear finds him/herself, simply providing a communications headwear apparatus with merely an appropriately placed earphone may not be sufficient to allow the wearer to intelligibly receive audio communications from the earphone without ambient noise severely interfering.

In such a situation, and when ambient background noise becomes too great, the wearer is typically forced to employ a different headwear possessing sound-shielding earcups to suppress the amount of ambient background noise reaching the entrance of his/her ear and thereby enabling the audio communications systems from the earphone of the headset within the earcup to be intelligibly received by the wearer.

Unfortunately, this requires the use of two separate audio communications headwear devices, one with sound-attenuating earcups, and the other without. The wearer have a requirement to use the ear over which the communications earphone is positioned to receive not only audio headset communications, but also audio communications from his/her immediate environment (e.g. direct human voices). Headwear with ear cups would be unsuitable for this.

Headwear lacking ear cups are often flimsy or insubstantial in structure and/or uncomfortable when worn and/or susceptible to slippage about the wearers head in use especially when worn under a hat or helmet.

Thus, in order to allow a wearer to effectively use audio communications headwear in all of the above situations, he/she is typically required to possess two types of headwear, one with sound-attenuating earcups, and one without. This is both inconvenient and expensive, and illustrates one example of the current lack of versatility in the configuration of communications headwear of current types. The present invention aims to address at least some of these deficiencies in the prior art, and is concerned with increasing the re-configurability, robustness and versatility of communications headwear.

At its most general the present invention proposes a circum-aural platform member for use with a headset apparatus in which the platform member is shaped to circumscribe the ear of the wearer without covering that ear, but having means for detachably attaching headset apparatus, such as different earphone pieces, earcups or the like, to the platform. This may enable the platform member to be used as a part of a headwear assembly which may be not only reconfigured with a new headset apparatus (e.g. earphone piece), but possibly also reversibly reconfigured from an open circum-aural configuration in which the wearer's ear is exposed to the environment, to a closed-cavity circum-aural configuration using an earcup or the like to provide a degree of passive attenuation of ambient sound for improved communication intelligibility when worn in a significantly high noise environment. This also means that headsets used with a non-circum-aural mounting on a wearer's head (e.g. supra-aural) may now be used in a circum-aural mounting by using the circum-aural platform member.

Furthermore, the platform member may be configured in any desirable way suitable for allowing the detachable attachment of any number of existing headset assemplies (e.g. earphone assemblies) as used in e.g. existing audio communication headset devices. In this way, the present invention aims to provide a platform for (e.g. communications) headset apparatus having greater versatility and re-configurabillity together with the robustness and comfort to the wearer afforded by circum-aural shape.

In a first of its aspects, the present invention may provide headwear including a platform member for use with a headset apparatus the platform member defining an orifice therein and shaped to be placed adjacent and to surround an ear of the wearer to expose the ear though the orifice, wherein the platform member has a platform part moveable relative to another platform part to releasably hold between the platform parts at least a part of the headset apparatus thereby to detachably attach the headset apparatus to the platform member. For example, the headset apparatus may be a communications headset apparatus for use in communicating voice/sound messages between the wearer and a communications system or circuitry (wireless or otherwise).

The headset apparatus, which the platform member may be adapted to releasably hold, may include (but is not limited to) any one or more of: an earphone; a microphone; an ear shield or guard/protector; communications components or electronics; and antenna or antenna circuitry or the like.

The platform member may be arranged to contact parts of the head of the wearer in use directly (i.e. in direct contact), or indirectly via an intermediate cushion or the like.

For example, when the platform member is arranged to releasably hold a communications headset apparatus having an earphone, the platform member is preferably arranged to detachably attach the headset thereto to position the earphone at the orifice of the platform member without closing the orifice such that the platform member and headset apparatus do not wholly cover the parts of the wearer exposed by the orifice. The earphone of such a communications headset apparatus may include or provide an earphone connector member to which the parts of the platform member are designed to releasably hold thereby to detachably attach the headset apparatus to the platform member without placing the sound-emitting parts of the earphone between the platform parts. The earphone connector member may be a general connector member in the form of a boss, block or body to which other headset communications components (e.g. microphone, signal conduits/wiring etc) are connectable in common or separately, and may be a means via which communications input and/or output signal conduits/wires are connectable to headset components for allowing communication signals to pass to/from the headset apparatus to a separate communications system/channel.

Accordingly, the present invention may provide an open circum-aural platform member for a headset apparatus in which the headset apparatus (e.g. with an earphone piece) is easily detachably attachable to enable it to be replaced or otherwise reconfigured or repositioned or adjusted within the platform member without requiring the wholesale replacement of the headset apparatus. Consequently, where, for example, a user or wearer employs different earphone pieces separately served by different respective communications channels, he/she may replace one headset/earphone piece with the other headset/earphone piece simply and easily without requiring a change in the platform member via which the headset apparatus is mounted about the person of the wearer. The wearer simply being required to detach the currently attached headset/earphone piece and attach in its place the replacement/successor headset/earphone piece.

The platform member may have portions shaped to reciprocally match a shaping of a part of the headset apparatus to which the parts of the platform member are arranged to hold such that the former and the latter may be mated together in a close-fitting interference fit or snap-fit or by one being plugged on to or into the other (e.g. in a plug-and-socket arrangement) when held between the platform parts.

The platform member is preferably arranged to at least partially clasp, fold over/around or encapsulate at least a part of the headset apparatus such that the held headset part cannot be detached from the platform member without moving/separating or removing the part(s) of the platform member which hold, encapsulate or clasp the headset apparatus member when the latter is attached to the former. This arrangement is particularly beneficial in ensuring structural rigidity and physical robustness of the assembled apparatus thereby reducing the risk of unintentional disassembly of the apparatus through e.g. impact or shock to the apparatus.

Preferably, the platform member includes two or more separate platform parts moveable relative to each other from an opened position in which the headset apparatus is separable from the platform member to a closed position in which the headset apparatus is clasped to the platform member between platform parts.

The two or more separate platform parts may be completely separated from each other in the open position (e.g. physically disconnected), but more preferably the platform parts and moveably joined to each other so as to remain connected when moved to the opened position.

The two or more separate platform parts are preferably inter-lockable together in the closed position to grasp the earphone connector member in between the interlocked platform parts. In this way, the platform member holds on to the headset apparatus. The two or more moveable separate platform parts may be hingedly interconnected to be splayable from a closed position in which the parts are in overlapping opposition to one and other to the opened position by rotation about the hinged interconnection between the two parts. In this way, the platform parts of the platform member may be open and closed, in the manner of opening and closing a book, to releaseably clasp, encapsulate or grasp the headset apparatus therebetween.

It is to be understood that this manner of detachably attaching headset apparatus to the platform member may apply to any number of headset apparatus components/types. The clasping, encapsulating or grasping functionality of the platform member may be used to detachably attach an ear shield part (e.g. an impact shield or an earcup) to the platform member, or an ear cushion component (e.g. a circum-aural ear cushion) or electrical components of a communications headset apparatus such as switchboxes, communications wires, microphones, and electronics components or electronic circuit boards (e.g. antennae circuits for radio communications).

The present invention may provide apparatus including the platform member and the headset apparatus to which the platform member is arranged to hold, either in assembled form in which the latter is detachably attached to the former, or in disassembled form (e.g. a kit of parts) in which the latter is not attached to the former.

In a headset apparatus including an earphone, the earphone is preferably connected (e.g. flexibly) to other parts of the headset apparatus (e.g. to an earphone connector member) via a boom arm or rod and the orientation of the boom arm and/or other headset parts may be adjustable relative to the platform member to allow adjustment of the position of the earphone within the orifice.

The headset apparatus (e.g. being a part of the apparatus provided by the present invention) may be or include an shield member detachably attachable to the platform member to extend across the orifice of the platform member to shield parts of the ear of the wearer exposed by the orifice of the platform member. For example, the shield member may be attachable to a platform member to which a communications earphone is attachable to shield parts of the ear of the wearer not covered by the earphone when attached to the platform member. In this way, if the wearer considers that some form of ear shielding is required he/she may simply attach the required shield member to the platform member without requiring wholesale change of the assembly. The shield member may include a sound-shielding part such as an earcup or the like which covers up and closes the orifice of the platform member through which the ear of the wearer is otherwise exposed thereby to cut down on ambient noise levels reaching the wearer's ear. Alternatively, or additionally, the shield member may include impact protection framework which extends into or across the orifice of the platform member to be placed over the ear of the wearer to provide a physical buffer, barrier or frame/cage through which ambient sound can easily pass but which offers some protection from impact or collision of objects with the ear exposed by the orifice of the platform member in use.

The shield member may be an impact shield including a rigid or resilient frame which extends across the orifice of the platform member when attached thereto so as to protect from impacts the ear of the user exposed by the orifice without closing the orifice. In this way, impact protection may be added to the platform member without loss of the wearer's ability to hear ambient sounds (e.g. voices). However, should ambient noise be unacceptable high, an earcup may be detachably attached to the platform member.

The shield member may be an ear cup including a sound shield portion which extends across the orifice of the platform member when attached thereto so as to cover the an ear of the user exposed by the orifice thereby closing the orifice and attenuating external sound incident towards the ear.

The two or more platform parts may differ in size and shape. For example, one of the platform parts may be a flap, door, strap or limb hingedly interconnected to another of the platform parts and moveable relative thereto between the opened and closed positions. Preferably, the two or more (e.g. annular) platform parts include two circum-aural parts which each separately circumscribe or surround the ear of the wearer.

Preferably, two of the platform parts each define a separate respective orifice therein such that in the opened position the orifices of the platform parts are separated and in the closed position the orifices are aligned to collectively define the orifice of the platform member. In this way, a shield member may, if required, be held, clasped or grasped by the closed platform parts at any part, or all parts, of the shield member surrounding or circumscribing the ear of the wearer in use. Alternatively, the ability of the platform parts to clasp a headset component at any region of the platform member surrounding the ear of the wearer in use enables a great degree of freedom in selectively positioning the detachably attachable part, clasped by the platform member, at any suitable location along the periphery of the orifice of the platform member.

Preferably, the shield member is separable from the platform member when two or more platform parts are in the opened position and is clasped to the platform member between platform parts in the closed position.

Preferably, all of the periphery of the shield member is clasped by the platform member when attached to the platform member in the closed position. The platform parts when in the closed position preferably clasp the shield member to form a sealing interface at the points of contact therebetween. This is especially beneficial in providing enhanced sound-proofing for the headset when the shield is an earcup.

The two platform parts are preferably joined by a hinge means about which they are moveable between the opened and closed positions. Preferably, the two platform parts may be operable such that the orifice of the platform member, or of any of the parts of the platform member, is or remains intact and the periphery of the platform member (or platform part) defining it remains unbroken. In this way, maintaining the unbroken structural integrity of the annular shape of the platform member (or the parts thereof) retains the strength and form of the platform member).

The apparatus may include an ear cushion member detachably attachable to the platform member and having a portion including a compliant material positionable over an outer surface of the platform member adjacent the ear of the wearer when the ear cushion member is attached to the platform member.

Preferably, the two parts of the platform member are mutually shaped such that the shape of one of the parts is substantially a mirror image of the shape of the other of the parts. In this way, the mirror-image symmetry of the shapes of the two parts of the platform member enables the functionality and structure of one of the two parts to substantially mirror the functionality and structure of the other of the two parts. For example, the shape and configuration of the body of one of the two parts and the shape and configuration of surface structures shapes and formations upon it may substantially be the mirror image of the corresponding shapes, configurations and structures on the other of the two platform members. For example, the structure of one of the two parts may be substantially identical to that of the other of the two parts in mirror-image. In this way, the platform member may be structured to “look” the same and to have the same functionality when placed around either the left ear or the right ear of a wearer. Consequently, the outwardly presented surface of one of the two parts of the platform member is preferably a mirror image of the outwardly presented surface of the other of the two parts. Most preferably, the shape and configuration of the inwardly-presented surface of one of the two parts, when in the closed position, is substantially a mirror image of the opposing inwardly presented surface of the other of the two parts. In this way, a component of a headset apparatus, such as an earphone connector member or a shield member, is clasped between opposing mirror-image platform member parts when the latter are in the closed position. Thus, as “seen” by the clasped or encapsulated communications headset component, the clasping inwardly-presented surfaces of the platform member parts do not enable a distinction as between whether the circum-aural platform member is arranged around the left ear of the wearer or the right ear of the wearer. As a consequence, the structure or shape or the clasped headset component need not be adjusted when swapping the platform member from left-ear use to right-ear use on the wearer, or vice versa.

The plane of mirror symmetry is preferably the plane across which the two platform parts oppose each other when the platform member is in the closed position (e.g. the plane containing the axis of hinged rotation about which the two parts separate when the platform member is being opened).

Preferably, one or both of the two platform parts possesses a recessed region (e.g. channel or groove or the like) positioned to be opposed by the other of the two platform parts when in the closed position such that the parts of the recessed region of the platform part are further from the opposing regions of the other platform part than are regions of the platform part adjacent the recessed region.

The recessed region preferably defines a cavity or a channel dimensioned to receive parts of one or more of: a component of a communications headset (e.g. an earphone connector member); a shield member; the ear cushion member; an item of electrical or electronic circuitry; communications signal conduits.

The two or more platform parts may be releasably securable together in the closed position by a mutual snap-fit join between the opposing surfaces (or parts thereof) of the parts (e.g. a lug formation on one platform part arranged to interface with a corresponding and opposing socket on the other platform part). Alternatively, fixing means such as screws, bolts or straps may be used.

It will be understood that the present invention, in a second of its aspects, may provide apparatus according to the invention described above (e.g. in its first aspect) in assembled form including headset apparatus or components. It will also be understood that the invention described above in terms of apparatus including a platform member and a headset apparatus encompasses within its scope a method of assembling the apparatus into a headwear in assembled form.

For example, in a second of its aspects, the present invention may provide a method of assembling a headwear apparatus including providing a platform member and a headset apparatus, wherein the platform member defines an orifice therein and is shaped to be placed adjacent and to surround an ear of the wearer to expose the ear though the orifice, the method including moving a part of the platform member relative to another part thereof to releasably hold between the platform parts at least a part of the headset apparatus thereby to detachably attach the headset apparatus to the platform member. For example, the headset apparatus may be a communications headset apparatus for use in communicating voice/sound messages between the wearer and a communications system or circuitry (wireless or otherwise).

The method may include detachably attaching to the platform member a communications headset apparatus having an earphone, to position the earphone at the orifice without closing the orifice such that the platform member, and headset do not wholly cover the parts of the wearer exposed by the orifice. The communications headset may include an earphone attached to an earphone connector member to which the platform member is arranged to releasably hold.

The method preferably includes providing the platform member with two or more separate and relatively moveable platform parts, and moving one of the platform parts relative to each other from an opened position in which the headset apparatus (e.g. earphone connector member) is separable from the platform member to a closed position in which the headset apparatus is clasped to the platform member between platform parts.

The method may include providing a shield member and detachably attaching the shield member to the platform member to extend across the orifice of the platform member to shield parts of the ear of the wearer exposed by the orifice of the platform member. Where the headwear includes an earphone, the shield may shield those parts of the wear's ear not covered by the earphone (or earphone connector) when attached to the platform member.

Preferably, the method includes clasping the shield member to the platform member between platform parts in the closed position.

In the method, the shield member may be an impact shield including a rigid frame which extends across the orifice of the platform member when attached thereto so as to protect from impacts the ear of the user exposed by the orifice without closing the orifice. The shield member may be an ear cup including a sound shield portion which extends across the orifice of the platform member when attached thereto so as to cover the an ear of the user exposed by the orifice thereby closing the orifice and attenuating external sound incident towards the ear.

The method may include providing two of the platform parts to each define a separate respective orifice therein such that in the opened position the orifices of the platform parts are separated, and positioning the orifices of the platform parts in the closed position to be aligned to collectively define the orifice of the platform member.

The method may include clasping all of the periphery of the shield member with the platform member when attached to the platform member in the closed position.

Preferably, the method includes clasping the shield member with the platform parts in the closed position to form a sealing interface at the points of contact between the shield member and the platform member.

The method may include providing an ear cushion member having a portion including a compliant material, and detachably attaching the ear cushion member to the platform member to position the compliant material over an outer surface of the platform member adjacent the ear of the wearer.

Preferably, the method includes providing one or both of the two platform parts with a recessed region positioned to be opposed by the other of the two platform parts when in the closed position such that the parts of the recessed region of the platform part are further from the opposing regions of the other platform part than are regions of the platform part adjacent the recessed region.

In the method, the recessed region preferably defines a cavity or a channel, and positioning within the cavity parts of one or more of: the earphone or earphone connector member; a shield member; the ear cushion member; an item of electrical or electronic circuitry; communications signal conduits.

There now follow non-limiting examples of the invention with reference to the accompanying drawings in which:

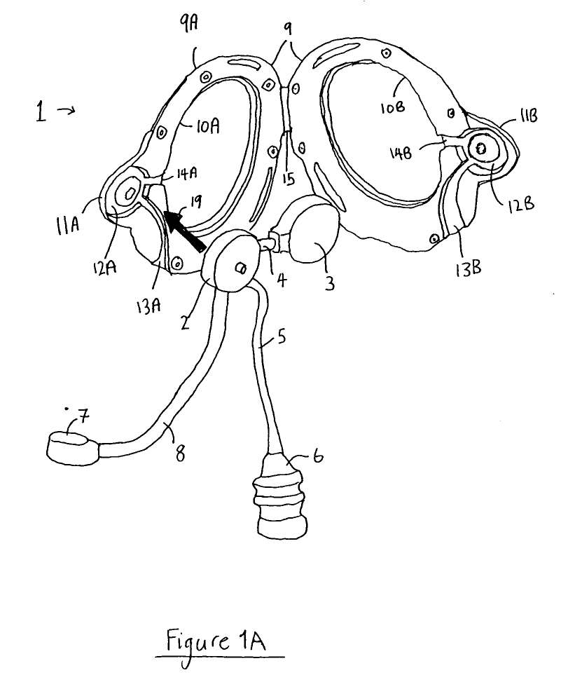

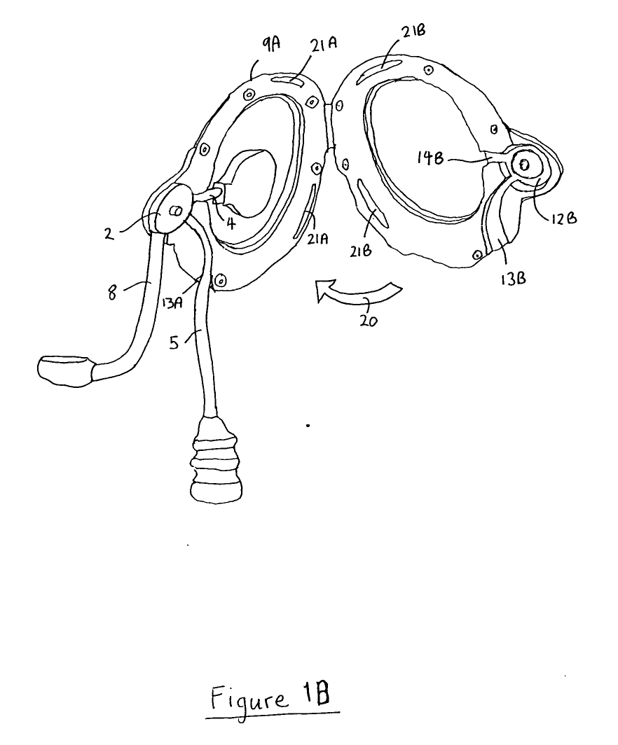

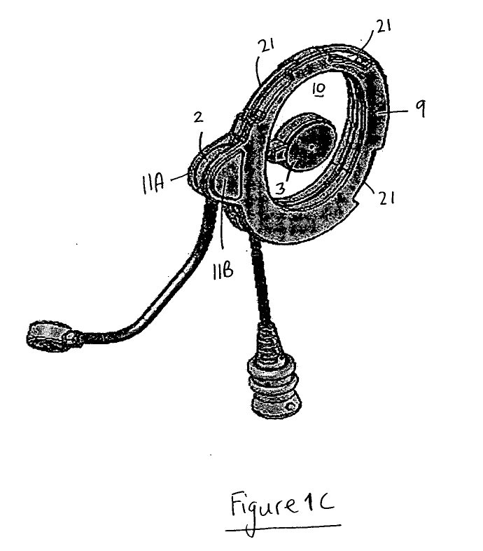

FIG. 1A shows an exploded view of disassembled components of a communications headwear apparatus including audio communications headset apparatus detachably attachable to a two-part hinged circum-aural platform member shown in an opened state for receiving the audio communications headset apparatus;

FIG. 1B shows the arrangement of FIG. 1A in which a shaped portion of the audio communications headset apparatus is received in a reciprocally shaped recess formed in a surface of one of the two hinged circum-aural platform parts;

FIG. 1C shows the arrangement of FIG. 1B with the two hinged circum-aural platform parts in a closed position with the audio communications headset apparatus clasped between the two circum-aural platform parts;

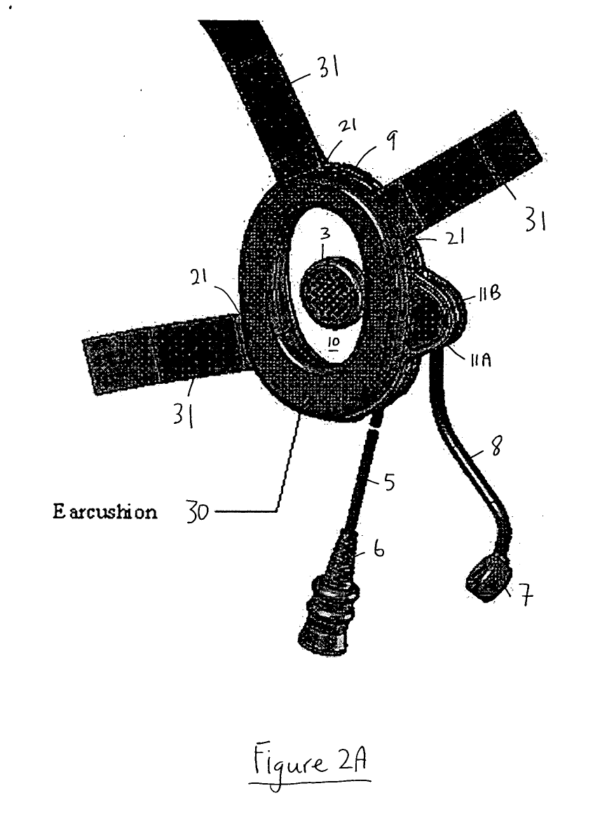

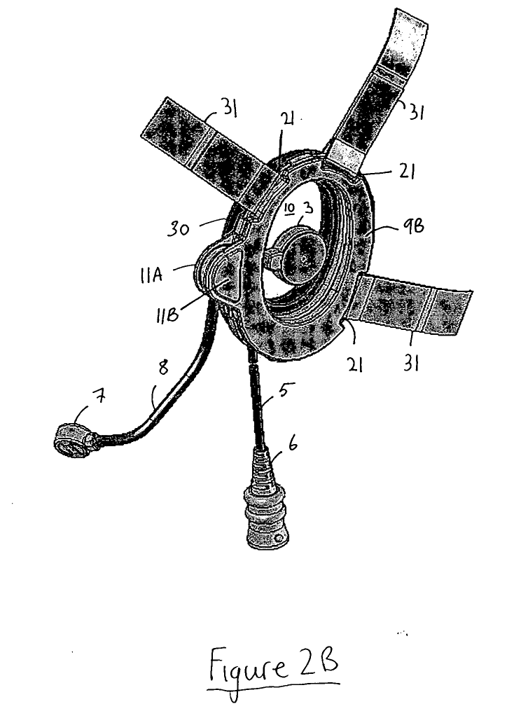

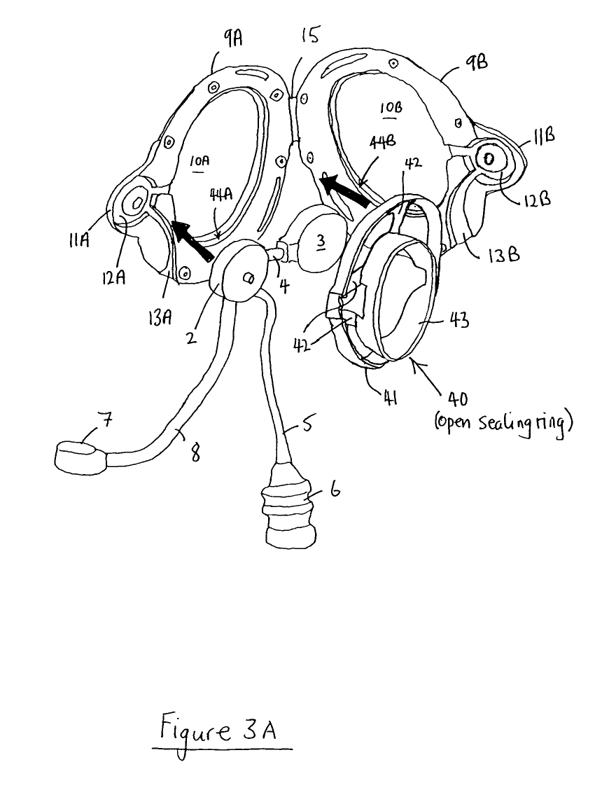

FIG. 2A shows the arrangement of FIG. 1C in which the assembled circum-aural communications headwear apparatus has attached to it a circum-aural ear cushion and head straps each being attached to the circum-aural platform member;

FIG. 2B illustrates a view of the assembled communications headwear apparatus of FIG. 2A viewed from the other side;

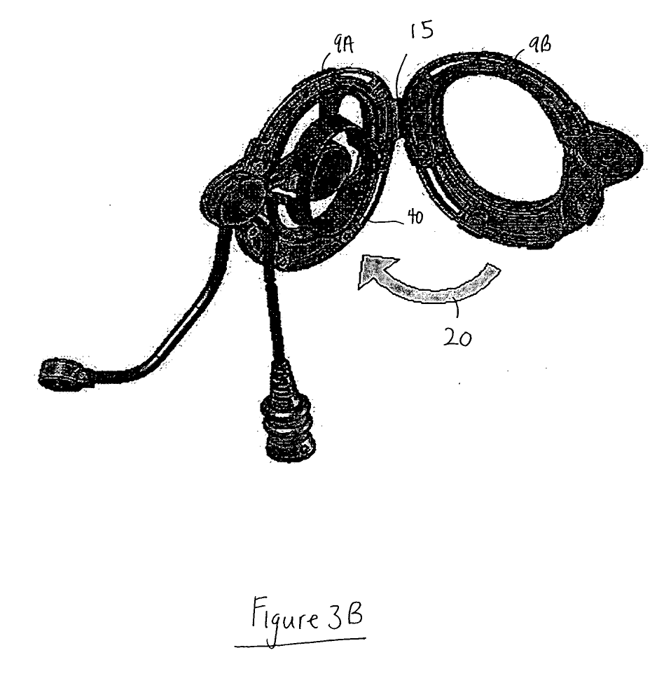

FIG. 3A illustrates an exploded view of components of a communications headwear apparatus in disassembled form comprising the apparatus illustrated in FIG. 1A and further including an ear shield frame detachably attachable to the platform member between the two hinged circum-aural platform parts when closed;

FIG. 3B illustrates the arrangement of FIG. 3A with the ear shield frame periphery mounted within reciprocally shaped recesses formed with the surface of one of the two hinged circum-aural platform parts prior to closing of the platform parts to clasp the ear shield frame in position;

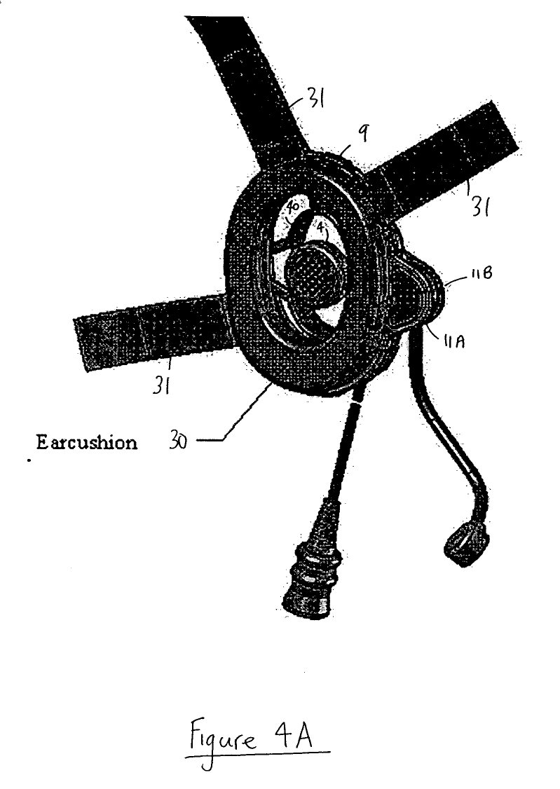

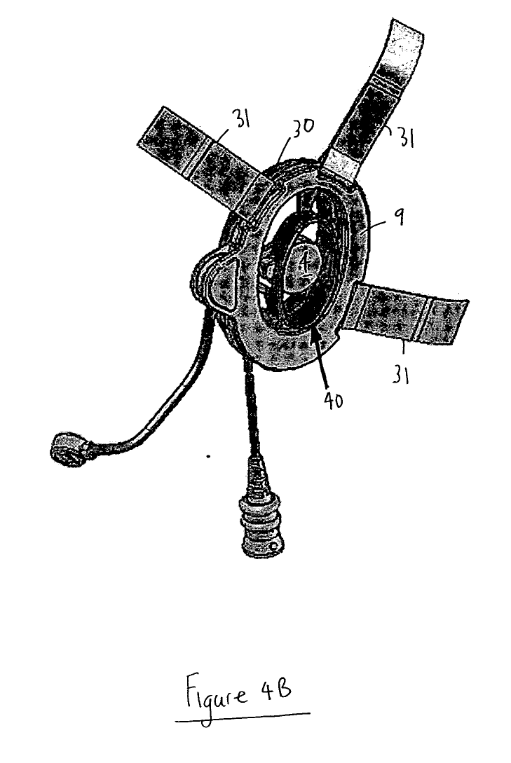

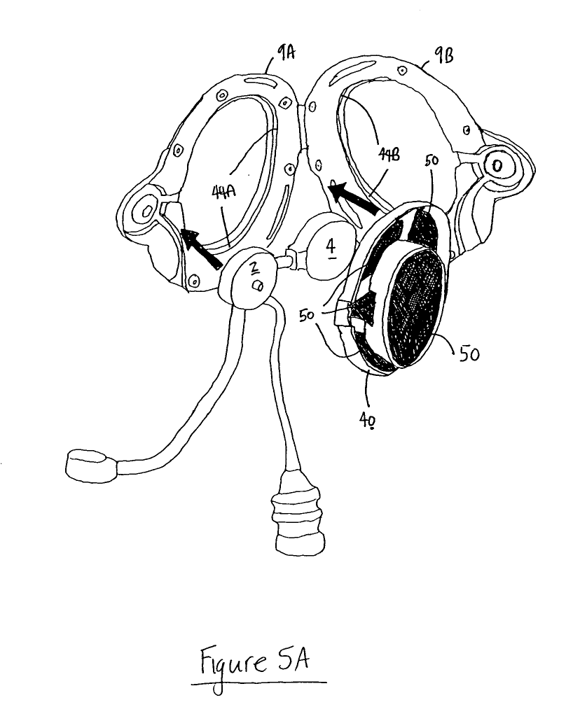

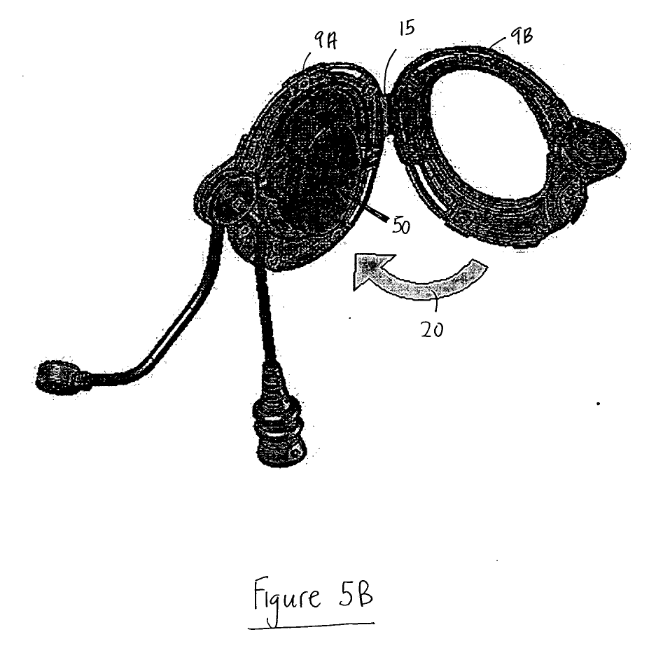

FIG. 4A illustrates the arrangement of FIG. 3B in fully assembled form with the hinged circum-aural platform parts in a closed position clasping the ear shield part therebetween, and further including an ear cushion and headstraps;

FIG. 4B illustrates the arrangement of FIG. 4A viewed from the other side thereof;

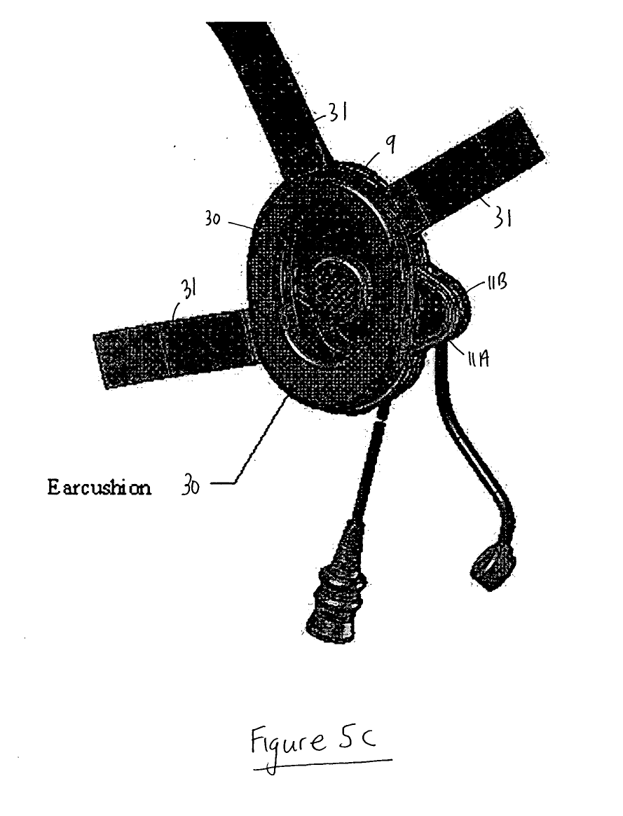

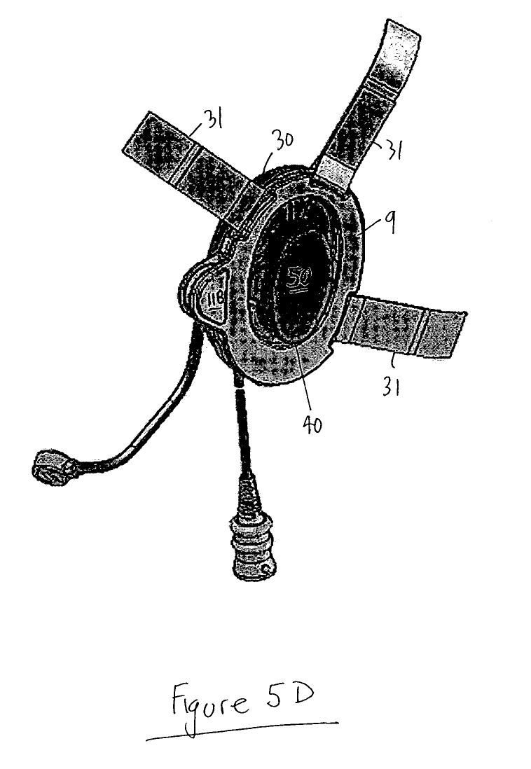

FIGS. 5A, 5B, 5C and 5D illustrate the communications apparatus illustrated in FIGS. 3A, 3B, 4A and 4B respectively in which the ear shield component further comprises a noise excluding cover.

In the figures, like reference symbols are assigned to like articles for the purposes of consistency.

FIG. 1A illustrates an exploded view of components of a single-sided open cavity circum-aural communications headwear apparatus (1) in disassembled form. The apparatus includes a communications headset apparatus including an earphone connector member in the form of a headset boss (2) from a side of which extends an earphone boom arm (4) to the end of which is connected an earphone (3). A boom microphone (7) is connected to the headset boss (2) by a microphone boom arm (8). A communications signal conduit cable (5) extends from the headset boss (2) and terminates with a cable connector (6) which is arranged for connection to signal cabling or sockets of a communications apparatus with which the illustrated communications headset is intended to be used.

A communications signal conduit cable (5) contains wiring via which electrical signals may be conveyed via the headset boss (2) and earphone boom arm (4) to the earphone (3) of the headset to allow audio communications signals to be generated thereat. Similarly, electrical wiring passes from the microphone (7) along and within the microphone boom arm (8), through the headset boss (2) and to an external communications system via the communications signal cable (5) and the terminal cable connector (6) thereof. In this way, a two-way audio communications apparatus is provided, being mounted upon a common single boss (2). The earphone (3) is arranged to be positioned at or adjacent the entrance of the ear of the wearer of the headset apparatus, with the microphone (7) being simultaneously positioned adjacent the mouth of the wearer.

To enable this positioning, the headwear apparatus includes a single-sided open cavity circum-aural platform member (9) defining an orifice (10A, 10B) and shaped to be placed adjacent and to surround an ear of the wearer to expose the ear through the orifice. The earphone connector member (2, 4) is detachably attachable to the platform member (9) to position the earphone at the orifice of the platform member adjacent or over the entrance of the wearer's ear. The lateral dimensions of the orifice of the platform member (10A, 10B) exceeds the lateral dimensions of the earphone positionable within that orifice such that the earphone may be positioned within the orifice without closing the orifice. Consequently, when assembled, the headwear apparatus enables parts of the wearer's ear to remain exposed by the orifice of the platform member (9) thereby enabling the wearer to perceive not only audio communications from the earphone (3) but also to perceive substantially unobstructed or attenuated ambient sounds such as voices without having to remove the headwear from the ear to enable those ambient sounds to be heard. The circum-aural form of the platform member (9) provides greater structural rigidity and strength to the headwear apparatus, enables a circum-aural ear cushion member to be attached thereto for greater comfort, and also enables a sealing interface to be formed between the platform member and the parts of the wearer's head surrounding or circumscribing the ear exposed through the orifice of the platform member. This circum-aural interface with the wearer's head increases the comfort to the user by distributing the interface over a greater area (commonly the platform member will be strapped to and against the wearer's head), allows a much greater area of grip between the platform member and the wearer's head thereby reducing the possibility or extent of slippage or movement of the platform member across the head during use, but particularly is useful in providing a sealing interface with the wearer's head which becomes paramount should the wearer choose to re-configure the headwear apparatus to a covered or closed-cavity arrangement (e.g. using a sound-attenuating earcup) as opposed to the exposed open-cavity arrangement illustrated in FIG. 1A.

The headwear platform member (9) comprises two separate platform parts (9A, 9B) moveably joined to each other by a hinge or flexible strip of material (15). Each of the two platform parts is annular in form and each defines a separate respective orifice (10A, 10B) therein. The platform parts are moveable or pivotal about the hinge (15) joining them from an opened or splayed position in which the parts are separated (while remaining joined at the hinge) to a closed position in which the respective orifices of the two platform parts are aligned such that their peripheries coincide and such that they collectively define the orifice (10) of the platform member through which the ear of the wearer will be exposed. In this way, the two hingedly joined annular platform parts may be splayed to an open position, in the manner of opening a book, and subsequently closed to define an assembled headwear platform member. In the opened position the boss (2) of the earphone connector member is separable from the platform member (9), while in the closed position the boss is clasped to the platform member between opposing surfaces of the two aligned and overlapping annular platform parts.

Each of the annual platform parts possesses a flange portion (11A, 11B) protruding from the outer peripheral edge of the annular body of the respective platform part and being dimensioned to cover one side of the communications headset boss (2) of the earphone connector of the headset. Each of these flanges has a recessed region (12A, 12B) positioned to be opposed by a corresponding recessed region in the other of the two platform parts when in the closed position thereby to collectively define a cavity or socket region shaped and dimensioned to reciprocally match the shape and configuration of the boss (2) of the earphone connector thereby to intimately receive and retain the boss member within and between the two recessed portions (12A, 12B) of the platform parts when closed. In this way, the headset boss (2) and all the components connected to it, may be detachably attached to the headwear platform member (9) by initially separating the two hingedly joined platform parts into an opened position thereby revealing the recessed socket regions (12A, 12B) of each platform part, subsequently positioning the boss member within either one of those recesses, and thereafter bringing the two platform parts into the closed position by drawing the two together to position the boss between the two flange parts (11A, 11B) of the platform parts thereby housing and retaining it within the cavity defined by the two opposing recessed regions (12A, 12B) of the platform parts in the closed position. Detachment of the headset boss (2) from the platform member may simply be achieved by reversing this operation.

Furthermore, additional recesses are formed within the surfaces of the platform parts which oppose each other in the closed state and which are shaped and configured to receive those parts of the earphone boom arm (4) and the signal conduit cable (5), which extend from the headset boss (2) and which are clasped between the platform parts when in the closed position. In particular, recessed channels (14A, 14B) extend from the boss-receiving recess in each of the two platform parts (9A, 9B) and extends all the way to the inner annular periphery (i.e. the orifice periphery) of the respective platform member thereby being opened to and in communication with the orifice (10A, 10B) defined thereby. Corresponding such channels (14A, 14B) are positioned to oppose and be aligned with each and other when the two respective platform parts are drawn together in the closed position. Similarly, recess channels (13A, 13B) extend from the boss-receiving recess of a given platform part and terminate at the outermost annular periphery of the given annual platform part being open at that terminal end.

FIGS. 1A, 1B and 1C illustrate the sequence of events in the assembly of the communications headwear apparatus via which the boss member (2) of the earphone connector is attached to the platform member of the headwear. Referring to FIG. 1A, as described above, the boss (2) of the earphone connector is inserted into a reciprocally shaped recess socket (12A) of one of the two platform parts (9A) in the manner generally indicated by arrow 19 of FIG. 1A. FIG. 1B illustrates the partially assembled headwear apparatus immediately after the boss of the earphone connector has been inserted into the boss socket of one of the two platform parts, and illustrates with arrow (20) the subsequent closing movement (about hinge 15) of the other of the two platform parts (9B) to ultimately result in closure of the platform parts and a finally assembled headwear apparatus with the earphone connector boss (2) clasped to the platform member between platform parts as illustrated in FIG. 1C. Loop portions (21A, 21B) are arranged in the outermost regions of the annular periphery of each of the two platform parts (9A, 9B) respectively. Each such loop is a substantially slot-shaped orifice formed in the body of the respective platform part and positioned to align with a corresponding slot-shaped orifice in the other of the two platform parts so as to collectively define a single slot-shaped loop (21) when the two platform parts are in the closed position as illustrated in FIG. 1C. Head straps may be passed through these loops for connection to the platform member (9) for use in strapping the platform member to the head of the wearer as illustrated by the three separate head straps (31) attached to the closed platform member (9) of the fully assembled communications headwear apparatus illustrated in FIGS. 2A and 2B which respectively show the inwardly-presented and outwardly-presented surfaces of the assembled communications headwear apparatus to which a circum-aural ear cushion (30) has been added by attachment thereof to the platform member (9) so as to extend over the inwardly-presented annular surface of the platform member.

FIG. 3A illustrates an exploded view of a communications headwear apparatus of the type illustrated in FIG. 1A, in disassembled form, further including an ear shield member (40) which is detachably attachable to the platform member (9) so as to extend across the orifice of the platform member and to shield parts of the ear of the wearer exposed by the orifice of the platform member and not covered by the earphone (3) when attached to the platform member. The shield member (40) serves as an impact shield and includes a rigid frame (41, 42, 43) which extends across the orifice of the platform member when attached thereto so as to protect the exposed ear of the wearer from impacts without fully closing the orifice of the platform member. In this way the ear shield may provide impact protection to the wearer's ear without significantly reducing the ability of the wearer to perceive ambient noise through the orifice of the frame (e.g. human voices or the like).

The shield member (40) comprises a frame having an annular outermost frame member (41) shaped to substantially match the annular shape or dimensions of the platform member (9) to which it is to be detachably attached in use, and radially inwardly from which extend a number of frame spokes (42) which each terminate at an outer surface portion of a common inner ring member of a frame (43). In this way, the radial spokes (42) extending from the inner annular rim of the outermost frame member (41) of the frame collectively support the inner ring member (43) of the frame. The frame is constructed of substantially rigid or resilient material such as hard plastics material.

Each of the two hinged circum-aural platform parts (9A, 9B) possesses a respective recessed channel or groove (44A, 44B) extending across the surface of the respective part to substantially fully circumscribe the respective orifice (10A, 10B) defined by that part and also being positioned such that the circumscribing channel is fully aligned with and opposes all parts of the corresponding annular recessed channel of the other of the two platform parts when those two platform parts are in the closed position.

The shape of each of these recessed annual circumscribing channels is arranged to substantially reciprocally match the shape of an edge of the outermost annular rim of the outermost frame member (41) of the shield member (40) such that the rim may be intimately received within the channels. The recessed annual channels (44A, 44B) and the dimensions and shape of the outermost frame member (41) of the shield member are collectively constructed and arranged such that when the outermost frame member is inserted into the annual recessed channel of a first of the two hinged platform parts, with the platform member in an opened position, the second of the two platform parts may be pivoted about the interconnecting hinge to close the two platform parts and to position within the recessed annular channel of the second (closing) platform part those edges of the annular rim of the outermost frame member (41) which remain exposed from the platform member in the opened position.

As a result, the annular rim part of the outermost frame member (41) of the shield (40) is clasped between the closed platform parts of the platform member of the headset apparatus. The height or thickness of the annular rim of the outermost frame member (41) is dimensioned to ensure that, in the closed position, surfaces of the recessed annular channels (44A, 44B) of both of the two platform parts form a sealing interface with the frame's annular rim thereby enabling a degree of soundproofing therebetween should the shield be adapted to function as an acoustic ear shield as is discussed in more detail below. FIG. 3B illustrates the communications headwear apparatus of FIG. 3A in partially assembled form with the annular rim of outermost frame member of the shield positioned within the circumscribing recessed channel of one of the two platform parts immediately prior to closure of the platform member by the folding of the other two platform parts in the manner indicated by arrow 20 of FIG. 3B.

FIGS. 4A and 4B illustrate examples of the assembled communications headwear apparatus of FIGS. 3A and 3B in fully assembled form and further including an ear cushion (30) and head straps (31) attached to the platform member of the headwear apparatus. The view of FIGS. 4A and 4B are from opposite sides of this assembled apparatus.

Referring to FIGS. 5A, 5B, 5C and 5D, there is illustrated the arrangement discussed above with reference to FIGS. 3A, 3B, 4A and 4B respectively, but in which the frame of the shield member (40) has incorporated within it a noise excluding cover member (50) thereby defining an ear cup/shield serving as a sound shield which extends across the orifice of the platform member (in the closed position) completely covering the orifice.

The noise excluding cover preferably includes sound attenuating material sufficient to effect a substantial attenuation of external sound incident towards the ear of the wearer covered thereby. FIGS. 5A and 5B illustrate the assembly step also illustrated in FIGS. 3A and 3B, and the reader is referred to the discussion of the latter two drawings for an explanation of the assembly procedure illustrated in FIGS. 5A and 5B. It is to be noted that the shaping and dimensions of the annular frame rim (41) of the noise excluding cover illustrated in FIGS. 5A and 5B, provides a sealing interface with the enclosing/clasping opposing surfaces of the recessed circumscribing channels (44A, 44B) of the two platform parts as discussed above. This sealing interface is especially beneficial in assisting in the sound attenuating affect of the ear cup defined by the combination of the shield frame and noise excluding cover thereof.

Once more, FIGS. 5C and 5D show views from opposite sides of the fully assembled communications headwear apparatus of FIGS. 5A and 5B further including an ear cushion (30) and head straps each attached to the closed platform member of the apparatus.

It is to be understood that the embodiments described herein are merely examples of the invention and that modifications and variants of these embodiments, such as would be readily apparent to the skilled person, are envisaged without departing from the scope of the invention.

1. Headwear including a platform member for use with a headset apparatus, the platform member defining an orifice therein and shaped to be placed adjacent and to surround an ear of the wearer to expose the ear though the orifice, wherein the platform member has a platform part moveable relative to another platform part to releasably hold between the platform parts at least a part of the headset apparatus thereby to detachably attach the headset apparatus to the platform member

2. Headwear apparatus according to claim 1 wherein the platform member includes two or more separate platform parts moveable relative to each other from an opened position in which the headset apparatus is separable from the platform member to a closed position in which the headset apparatus is clasped to the platform member between platform parts.

3. Headwear apparatus according to claim 1 including a shield member detachably attachable to the platform member to extend into the orifice of the platform member to shield parts of the ear of the wearer exposed by the orifice of the platform member.

4. Headwear apparatus according to claim 2 wherein the shield member is separable from the platform member when two or more platform parts are in the opened position and is clasped to the platform member between platform parts in the closed position.

5. Headwear apparatus according to claim 3 wherein the shield member is an impact shield including a resilient frame which extends across the orifice of the platform member when attached thereto so as to protect from impacts the ear of the user exposed by the orifice without closing the orifice.

6. Communications apparatus according to claim 3 wherein the shield member is an ear cup including a sound shield portion which extends across the orifice of the platform member when attached thereto so as to cover the an ear of the user exposed by the orifice thereby closing the orifice and attenuating external sound incident upon it towards the ear.

7. Headwear apparatus according to claim 2 wherein two of the platform parts each define a separate respective orifice therein such that in the opened position the orifices of the platform parts are separated and in the closed position the orifices are aligned to collectively define the orifice of the platform member.

8. Headwear apparatus according to claim 3 wherein all of the periphery of the shield member is clasped by the platform member when attached to the platform member in the closed position.

9. Headwear apparatus according to claim 3 wherein the platform parts when in the closed position clasp the shield member to form a sealing interface at the points of contact therebetween.

10. Headwear apparatus according to claim 2 wherein the two platform parts are joined by a hinge means about which they are moveable between the opened and closed positions.

11. Headwear apparatus according to claim 2 wherein an ear cushion member detachably attachable to the platform member and having a portion including a compliant material positionable over an outer surface of the platform member adjacent the ear of the wearer when the ear cushion member is clasped by the platform member between platform parts in the closed position.

12. Headwear apparatus according to claim 2 wherein the two parts of the platform member are mutually shaped such that the shape of one of the parts is substantially a mirror image of the shape of the other of the parts.

13. Headwear apparatus according to claim 2 wherein one or both of the two platform parts possesses a recessed region positioned to be opposed by the other of the two platform parts when in the closed position such that the recessed region of the platform part is further from the opposing regions of the other platform part than are regions of the platform part adjacent the recessed region.

14. Headwear apparatus according to claim 13 wherein the recessed region defines a cavity or a channel dimensioned to receive parts of one or more of: an earphone; an shield member; the ear cushion member; an item of electrical or electronic circuitry; communications signal conduits.

15. Headwear including the headset apparatus according to claim 14 in assembled or disassembled form.

16. A method of assembling a communications headwear apparatus including providing a platform member and a headset apparatus, wherein the platform member defines an orifice therein and is shaped to be placed adjacent and to surround an ear of the wearer to expose the ear though the orifice, the method including moving a part of the platform member relative to another part thereof to releasably hold between the platform parts at least a part of the headset apparatus thereby to detachably attach the headset apparatus to the platform member.

17. The method of claim 16 including providing the platform member with two or more separate and relatively moveable platform parts, and moving the platform parts relative to each other from an opened position in which the headset apparatus is separable from the platform member to a closed position in which the headset apparatus is clasped to the platform member between platform parts.

18. The method of claim 16 including providing an shield member and detachably attaching the shield member to the platform member to extend into the orifice of the platform member to shield parts of the ear of the wearer exposed by the orifice of the platform member.

19. The method of claim 16 including clasping the shield member to the platform member between platform parts in the closed position.

20. The method of claim 16 wherein the shield member is an impact shield including a rigid frame which extends across the orifice of the platform member when attached thereto so as to protect from impacts the ear of the user exposed by the orifice without closing the orifice.

21. The method of claim 16 wherein the shield member is an ear cup including a sound shield portion which extends across the orifice of the platform member when attached thereto so as to cover the an ear of the user exposed by the orifice thereby closing the orifice and attenuating external sound incident towards the ear.

22. The method of claim 16 including providing two of the platform parts to each define a separate respective orifice therein such that in the opened position the orifices of the platform parts are separated, and positioning the orifices of the platform parts in the closed position to be aligned to collectively define the orifice of the platform member.

23. The method of claim 18 including clasping all of the periphery of the shield member with the platform member when attached to the platform member in the closed position.

24. The method of claim 18 including clasping the shield member with the platform parts in the closed position to form a sealing interface at the points of contact between the shield member and the platform member.

25. The method of claim 17 including providing an ear cushion member having a portion including a compliant material, and detachably clasping the ear cushion member to the between parts of the platform member in the closed position to position the compliant material over an outer surface of the platform member adjacent the ear of the wearer.

26. The method of claim 17 including providing one or both of the two platform parts with a recessed region positioned to be opposed by the other of the two platform parts when in the closed position such that the recessed region of the platform part is further from the opposing regions of the other platform part than are regions of the platform part adjacent the recessed region.

27. The method of claim 26 wherein the recessed region defines a cavity or a channel, and positioning within the cavity parts of one or more of: an earphone; a shield member; the ear cushion member; an item of electrical or electronic circuitry; communications signal conduits.
